(19) United States
(12) Patent Application Publication
(10) Pub. No.: US 2013/0207785 A1
(43) Pub. Date: Aug. 15, 2013

(54) STORAGE CARTRIDGE CARRYING SYSTEM

(71) Applicant: Chyuan-Ruey LIN, Hsinchu County (TW)

(72) Inventor: Chyuan-Ruey LIN, Hsinchu County (TW)

(21) Appl. No.: 13/369,898

(22) Filed: Feb. 9, 2012

(51) Int. Cl. G06K 7/01

(52) U.S. Cl. 340/10.42

(57) ABSTRACT

A storage cartridge carrying system is used to store a storage cartridge for storing related semiconductor components, and has a remote host to monitor a storage status of the storage cartridge, and the system includes a sensor module, a storage cartridge ID identification module, having an inflating device with a flow controller, and a gas suction device with a hygrometer, and the modules and devices return measured data to the remote host, so that the storage status and storage environments of the storage cartridge can be monitored accurately.

### FIELD OF THE INVENTION

The present invention relates to a storage cartridge carrying system, in particular to the storage cartridge carrying system for storing semiconductor components into a storage cartridge.

### BACKGROUND OF THE INVENTION

As semiconductor technologies advance, many industries including display, semiconductor, and solar equipment industries have to move the position of related semiconductor components such as semiconductor wafers and photomasks when the related semiconductor components are processed or manufactured.

The related semiconductor components are generally placed in a special storage cartridge for transportation or storage in order to prevent the semiconductor components from being contaminated by impurities. In addition, when it is not necessary to use these related semiconductor components, they are stored in the storage cartridge on a specific carrying rack that can be accessed for future use.

However, the related semiconductor components stored in the storage cartridge usually incur a higher cost and a better storage environment to assure the high availability of the related semiconductor components.

### SUMMARY OF THE INVENTION

Therefore, it is a primary objective of the present invention to provide a storage cartridge carrying system capable of monitoring the storage statuses of a storage cartridge.

Another objective of the present invention is to provide a better storage environment for related semiconductor components to maintain a high availability of the related semiconductor components.

To achieve the aforementioned and other objectives, the present invention provides a storage cartridge carrying system used for storing related semiconductor components into a storage cartridge and a remote host for monitoring the storage status of the storage cartridge. The storage cartridge carrying system comprises: a carrying rack, having a carrying tray for disposing the storage cartridge; a sensor module, installed on the carrying tray, for sensing a disposing status of the storage cartridge, and generating a disposing status signal to be transmitted to the remote host; a storage cartridge ID identification module, installed on the carrying tray, and provided for reading an ID code of the storage cartridge, and generating an ID code signal to be transmitted to the remote host; an inflating device, having an inflating pipeline coupled to the carrying tray for transmitting a gas into the storage cartridge, and a flow controller, controlled by the remote host and provided for controlling a gas flow; and a gas suction device, having a gas draining pipeline coupled to the carrying tray for flowing out the gas and a hygrometer for measuring a gas humidity, and generating a humidity measurement signal to be transmitted to the remote host.

In a preferred embodiment, the sensor module comprises: a control optical sensor, installed on the carrying rack, for sensing whether there is an object disposed on the carrying tray, and generating a control optical sensing signal in the disposing status signal. In addition, the sensor module further comprises: three touch sensors, installed on the carrying tray for supporting three supporting portions of the storage cartridge, and the three touch sensors are used for sensing whether the storage cartridge is aligned precisely with the supporting portions, and generating three touch sensing signals in the disposing status signal correspondingly. In addition, the sensor module further comprises: at least two storage cartridge model identification touch sensors installed on the carrying tray and provided for the storage cartridge to trigger one of the at least two storage cartridge model identification touch sensors through a touch to generate a storage cartridge model identification touch sensing signal in the disposing status signal.

In a preferred embodiment, the flow controller is a mass flow controller.

In a preferred embodiment, the storage cartridge ID identification module is a radio frequency identification (RFID) sensor.

In a preferred embodiment, the control optical sensor includes a light transmitter and a light reflector disposed at positions opposite to the carrying tray and diagonally and slantingly installed on the carrying rack with a control mode.

Therefore, the storage status and related storage data of the storage cartridge can be accessed easily and the storage status and the storage environment of the storage cartridge can be monitored accurately.

### BRIEF DESCRIPTION OF THE DRAWINGS

FIG. 1 is a system block diagram of a storage cartridge carrying system in accordance with a preferred embodiment of the present invention; and

FIG. 2 is a schematic view of a layout of a carrying rack and a carrying tray of a storage cartridge carrying system in accordance with a preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

The storage cartridge carrying system of the present invention is provided for storing a storage cartridge, and the storage cartridge is provided for storing related semiconductor components such as semiconductor wafers or photomasks. The present invention can be applied in semiconductor factories, other factories requiring the storage of semiconductor chips or photomasks and other similar warehouses and factories.

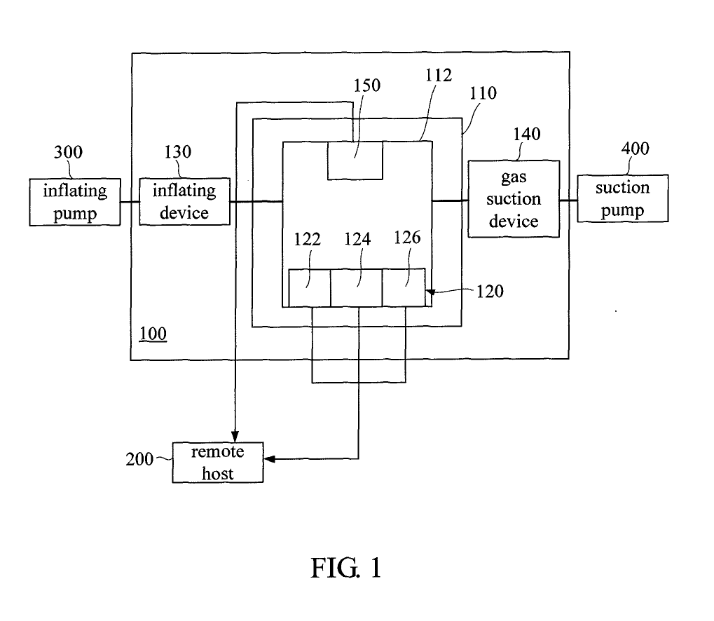

With reference to FIG. 1 for a system block diagram of a storage cartridge carrying system in accordance with a preferred embodiment of the present invention, the storage cartridge carrying system 100 comprises: a carrying rack 110, a sensor module 120, a storage cartridge ID identification module 150, an inflating device 130, and a gas suction device 140. The remote host 200 is coupled to components of the storage cartridge carrying system 100 to access storage status data of the storage cartridge.

The carrying rack 110 includes a carrying tray 112 for placing a storage cartridge (not shown in the figure), and this preferred embodiment adopts one carrying tray only, but actual implementations may have a plurality of carrying trays on the carrying rack 110 when needed, and the corresponding sensor module 120, storage cartridge ID identification module 150, inflating device 130, and gas suction device 140 also can come with a plural quantity to achieve the effect of monitoring the storage status of the storage cartridges at different locations.

The sensor module 120 is installed on the carrying tray 112 for sensing different disposing statuses of the storage cartridge to generate a disposing status signal and transmitting the disposing status signal to the remote host 200.

The storage cartridge ID identification module 150 is installed on the carrying tray 112 for reading an ID code of the storage cartridge and generating an ID code signal according to the ID code and transmitting the ID code signal to the remote host 200. The ID code can be a serial number of the storage cartridge, and a storage unit is installed on the storage cartridge for reading a storage cartridge ID identification module 150 which is provided for the control by the remote host 200. In a preferred embodiment, the storage cartridge ID identification module 150 can be a radio frequency identification (RFID) sensor for sensing an RFID tag installed on the storage cartridge.

The inflating device 130 has a flow controller (not shown in the figure) for transmitting gas to a pipeline (which is an inflating pipeline) of the carrying tray 112 and controlling a gas flow, and the flow controller can be controlled by the remote host 200 to control the volume of gas filled into the storage cartridge. Since related semiconductor components are stored in the storage cartridge, therefore the filled gas usually is an inert gas such as nitrogen. The storage cartridge carrying system 100 provides an inflating source through an inflating pump 300.

The gas suction device 140 includes a pipeline (which is a gas draining pipeline) for transmitting gas to the carrying tray 112 and a hygrometer (not shown in the figure) for measuring gas humidity. The storage cartridge carrying system 100 provides a draining gas source through a suction pump 400 for draining the gas in the storage cartridge to the outside. The gas suction device 140 together with the inflating device 130 can form a gas circulating storage space in the storage cartridge. In the gas draining pipeline, the hygrometer for measuring gas humidity can generate and transmit a humidity measurement signal to the remote host 200. Since the conventional way of controlling the inflation takes place after placing the storage cartridge and setting a predetermined time of the inflation, therefore the actual inflating condition cannot be controlled accurately, users cannot know about possible damage or leakage, and the semiconductor components in the storage cartridge may be damaged or cannot be used anymore. The low control and humidity monitoring of the present invention can effectively overcome the difficulty of controlling the inflating condition.

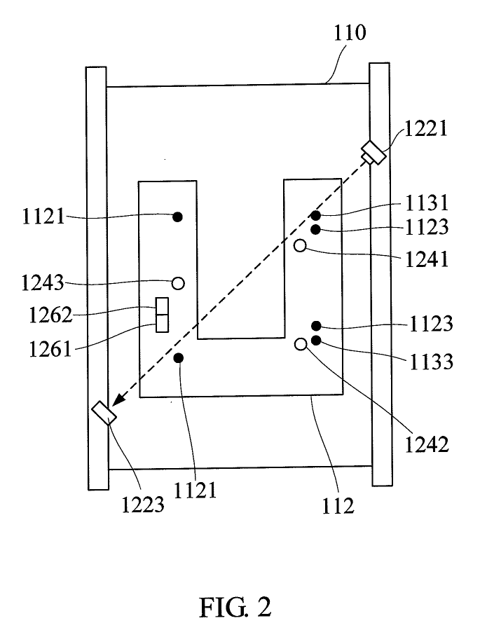

With reference to FIG. 2 for a schematic view of a layout of a carrying rack and a carrying tray of a storage cartridge carrying system in accordance with a preferred embodiment of the present invention, the sensor module 120 of the invention comprises a control optical sensor 122, a touch sensor 124, and a storage cartridge model identification touch sensor 126, or any combination of the three, and preferably the combination of the three. Therefore, an example of using the three types of sensors altogether as shown in FIG. 2 is used for illustrating the present invention.

The carrying tray 112 is coupled to the inflating device and the gas suction device, and the carrying tray 112 includes two gas inlets 1121 and two gas outlets 1123 formed on the carrying tray 112. The quantity and position of the gas inlets and gas outlets are provided for the purpose of illustrating the invention only, but they can be changed according to actual requirements. For example, two layouts of gas inlets and gas outlets can be designed on the carrying tray 112 to fit storage cartridges of two different specifications. The first layout has two gas inlets 1121 and two gas outlets 1123; and the second layout has one gas inlet 1131 and one gas outlet 1133.

The control optical sensor 122 can determine whether there is a storage cartridge placed on the storage tray 112 by a light reflection. In this preferred embodiment, the control optical sensor includes a light transmitter 1221 and a light reflector 1223, and they are disposed at oppositions opposite to the carrying tray 112 and diagonally and slantingly installed on the carrying rack 110 with a control mode. Wherein, the light transmitter 1221 is provided for transmitting light, and the light reflector 1223 is provided for reflecting the light transmitted from the light transmitter 1221. The light transmitter 1221 generates a control optical sensing signal in the disposing status signal.

The touch sensor 124 determines whether or not the storage cartridge is placed correctly by a press-down touch. In this preferred embodiment, there are three touch sensors 124 (including a touch sensor 1241, a second touch sensor 1242 and a third touch sensor 1243) installed on the carrying tray 112 for fixing the storage cartridge next to three bolts (not shown in the figure). The touch sensors 1241˜4243 generate three touch sensing signals in the disposing status signal respectively.

Since there is more than one type (at least two types) of the storage cartridges, and the required inflating gas draining holes are situated at different positions, therefore the storage cartridge model identification touch sensor 126 can be pressed downward or touched to identify the type of the storage cartridge. In general, each storage cartridge has a specially designed structure for the identification. In a preferred embodiment of the present invention, the identification signal is transmitted to the remote host 200. Therefore, the sensor module 120 further comprises at least two storage cartridge model identification touch sensors 1261, 1262 installed on the carrying tray 112 for driving the storage cartridge to trigger one of the at least two storage cartridge model identification touch sensors to generate a storage cartridge model identification touch sensing signal in the disposing status signal.

With the monitoring and detection by the sensor module and the gas suction device, the storage cartridge for storing related semiconductor component is preferably a carrying system, such that the storage status and storage environment of the storage cartridge can be monitored accurately.

While the invention has been described by means of specific embodiments, numerous modifications and variations could be made thereto by those skilled in the art without departing from the scope and spirit of the invention set forth in the claims.

What is claimed is:

1. A storage cartridge carrying system, used for storing a storage cartridge to store related semiconductor component, and providing a remote host to monitor a storage status of the storage cartridge, the storage cartridge carrying system comprising:
a carrying rack, having a carrying tray for disposing the storage cartridge;
a sensor module, installed on the carrying tray, for sensing a disposing status of the storage cartridge, and generating a disposing status signal transmitted to the remote host;
a storage cartridge ID identification module, installed on the carrying tray, for reading an ID code of the storage cartridge, and generating an ID code signal transmitted to the remote, host;
an inflating device, having an inflating pipeline coupled to the carrying tray for supplying a gas into the storage cartridge, and a flow controller controlled by the remote host and provided for controlling a gas flow; and
a gas suction device, having a gas draining pipeline coupled to the carrying tray for flowing out the gas, and a hygrometer for measuring a gas humidity, and generating a humidity measurement signal to be transmitted to the remote host.

2. The storage cartridge carrying system of claim 1, wherein the sensor module comprises:
a control optical sensor installed on the carrying rack for sensing whether an object is disposed on the carrying tray, and generating a control optical sensing signal in the disposing status signal.

3. The storage cartridge carrying system of claim 2, wherein the sensor module further comprises: three touch sensors installed on the carrying tray for supporting three supporting portions of the storage cartridge respectively, and sensing whether the storage cartridge is aligned with the supporting portions, and generating three touch sensing signals in the disposing status signal.

4. The storage cartridge carrying system of claim 3, wherein the sensor module further comprises:
at least two storage cartridge model identification touch sensors, installed on the carrying tray, and provided for the storage cartridge to trigger one of the at least two storage cartridge model identification touch sensors by a touch method, and for generating a storage cartridge model identification touch sensing signal in the disposing status signal.

5. The storage cartridge carrying system of claim 1, wherein the flow controller is a mass flow controller.

6. The storage cartridge carrying system of claim 2, wherein the flow controller is a mass flow controller.

7. The storage cartridge carrying system of claim 3, wherein the flow controller is a mass flow controller.

8. The storage cartridge carrying system of claim 4, wherein the flow controller is a mass flow controller.

9. The storage cartridge carrying system of claim 5, wherein the storage cartridge ID identification module is a radio frequency identification (RFID) sensor.

10. The storage cartridge carrying system of claim 6, wherein the storage cartridge ID identification module is a radio frequency identification (RFID) sensor.

11. The storage cartridge carrying system of claim 7, wherein the storage cartridge ID identification module is a radio frequency identification (RFID) sensor.

12. The storage cartridge carrying system of claim 8, wherein the storage cartridge ID identification module is a radio frequency identification (RFID) sensor.

13. The storage cartridge carrying system of claim 2, wherein the control optical sensor comprises a light transmitter and a light reflector, installed at positions disposed opposite to the carrying tray and diagonally and slantingly installed on the carrying rack with a control mode.

14. The storage cartridge carrying system of claim 3, wherein the control optical sensor comprises a light transmitter and a light reflector, installed at positions disposed opposite to the carrying tray and diagonally and slantingly installed on the carrying rack with a control mode.

15. The storage cartridge carrying system of claim 4, wherein the control optical sensor comprises a light transmitter and a light reflector, installed at positions disposed opposite to the carrying tray and diagonally and slantingly installed on the carrying rack with a control mode.

16. The storage cartridge carrying system of claim 13, wherein the flow controller is a mass flow controller.

17. The storage cartridge carrying system of claim 14, wherein the flow controller is a mass flow controller.

18. The storage cartridge carrying system of claim 15, wherein the flow controller is a mass flow controller.

19. The storage cartridge carrying system of claim 16, wherein the storage cartridge ID identification module a radio frequency identification (RFID) sensor.

20. The storage cartridge carrying system of claim 17, wherein the storage cartridge ID identification module a radio frequency identification (RFID) sensor.

21. The storage cartridge carrying system of claim 18, wherein the storage cartridge ID identification module a radio frequency identification (RFID) sensor.
